(19) United States
(12) Patent Application Publication
(10) Pub. No.: US 2015/0317466 A1
(43) Pub. Date: Nov. 5, 2015

(54) CERTIFICATE VERIFICATION SYSTEM AND METHODS OF PERFORMING THE SAME

(71) Applicant: Verificient Technologies, Inc., New York, NY (US)

(72) Inventors: Rajnish Kumar, Princeton, IL (US); Apratim Dutta, New York, NY (US)

(21) Appl. No.: 14/702,350

(22) Filed: May 1, 2015

Related U.S. Application Data
(60) Provisional application No. 61/987,650, filed on May 2, 2014.

(51) Int. Cl. G06F 21/32; G06F 21/33; H04W 12/06; H04L 29/06

(52) U.S. Cl. CPC G06F 21/32; H04L 63/0823; H04L 63/0861; G06F 21/33; H04W 12/06

(57) ABSTRACT

A system for generating certificates, the system include a certification generation unit having a processor and a memory with an application in the memory executing the steps of generating a digital certificate, retrieving verification information from a user where the verification information are unique to the user, appending a certificate content onto the verification information, appending an issuing authority identifier to the verification information, appending metadata to the verification information, embedding the appended verification information into the digital certificate, encoding the digital certificate with the embedded information, and issuing the encoded digital certificate.

### RELATED APPLICATIONS

This application claims the benefit of and the priority from U.S. provisional Application No. 61/987,650 filed May 2, 2014 entitled CERTIFICATE VERIFICATION SYSTEM AND THE METHODS OF PERFORMING THE SAME, which is incorporated in its entirety herein by reference.

### BACKGROUND OF THE INVENTION

The present invention relates generally to the verification of an individual using biometric information. As technology advances, the use of biometric information to verify individuals has increased. However, gathering and verification of biometric information has required the installation of cumbersome biometric reading devices that rely on biometric templates used to confirm biometric information that must be transmitted to the verifying device. A need exists for a system that will embed biometric information into a form that is easily transportable.

### BRIEF SUMMARY OF THE INVENTION

One embodiment of the present disclosure includes a system for generating certificates, the system include a certification generation unit having a processor and a memory with an application in the memory executing the steps of generating a digital certificate, retrieving verification information from a user where the verification information are unique to the user, appending a certificate content onto the verification information, appending an issuing authority identifier to the verification information, appending metadata to the verification information, embedding the appended verification information into the digital certificate, encoding the digital certificate with the embedded information, and issuing the encoded digital certificate.

In another embodiment, the verification information is biometric information from the user.

In another embodiment, the biometric information is at least one of a fingerprint scan, an iris scan, a facial scan or a knuckle scan.

In another embodiment, the verification information is a digital representation of the signature of the user.

In another embodiment, the digital certificate is a digital image.

In another embodiment, the certification generation unit is a mobile device.

In another embodiment, the verification information is a quick response code generated from biometric information gathered from the user.

In another embodiment, the verification information includes information based on features of the biometric data.

In another embodiment, the verification information is embedded into the graphical image as a pattern of shapes on the border of the image.

In another embodiment, the verification information is embedded into the graphical image as a pattern of shapes on the border of the image.

Another embodiment of the present disclosure includes a system of verifying a user, the system including a verification unit having a processor and a memory with an application in the memory executing the steps of retrieving a digital certificate from a user, decoding the digital certificate, extracting verification information from the decoded digital certificate where the verification information is unique to the user associated with the digital certificate, retrieving verification information from the user, comparing the verification information from the user with the extracted verification information and verifying the digital certificate as being generated by the user if the extracted verification information matches the retrieved verification information.

In another embodiment, the user directs the verification unit to a location storing the digital certificate.

In another embodiment, the verification unit captures an image of the digital certificate.

In another embodiment, the verification unit is a mobile device.

In another embodiment, the verification information is biometric information from the user.

In another embodiment, the biometric information is at least one of a fingerprint scan, an iris scan, a facial scan or a knuckle scan.

In another embodiment, the verification information is a digital representation of the signature of the user.

In another embodiment, the digital certificate is a digital image.

In another embodiment, the mobile communication device includes a public and private key and a verification information template to decode the digital certificate and extract the verification information.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 depicts a block diagram of an Certificate Management System suitable for use with the methods and systems consistent with the present invention;

FIG. 2 shows a more detailed depiction of the computer of FIG. 1;

FIG. 3 shows a more detailed depiction of the computers of FIG. 1;

FIG. 4 depicts a schematic representation of a system generating a certificate;

FIG. 5 depicts a schematic representation of a generating a certificate by embedding the certificate code with actual certificate content into a physical or digital certificate; and

FIG. 6 depicts one a schematic representation of the certificate verification unit verifying a certificate.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claim and any equivalents.

The present invention discloses a verification certificate that can be used to encrypt biometric data. The certificate includes source code that encrypts the biometric information of a user to whom the certificate is being issued. The source code is generated by a trusted authority that is generated using any known message encryption technique, for example a hash function that takes a biometric feature vector as input and generates a code that is representable as one or more QR-codes.

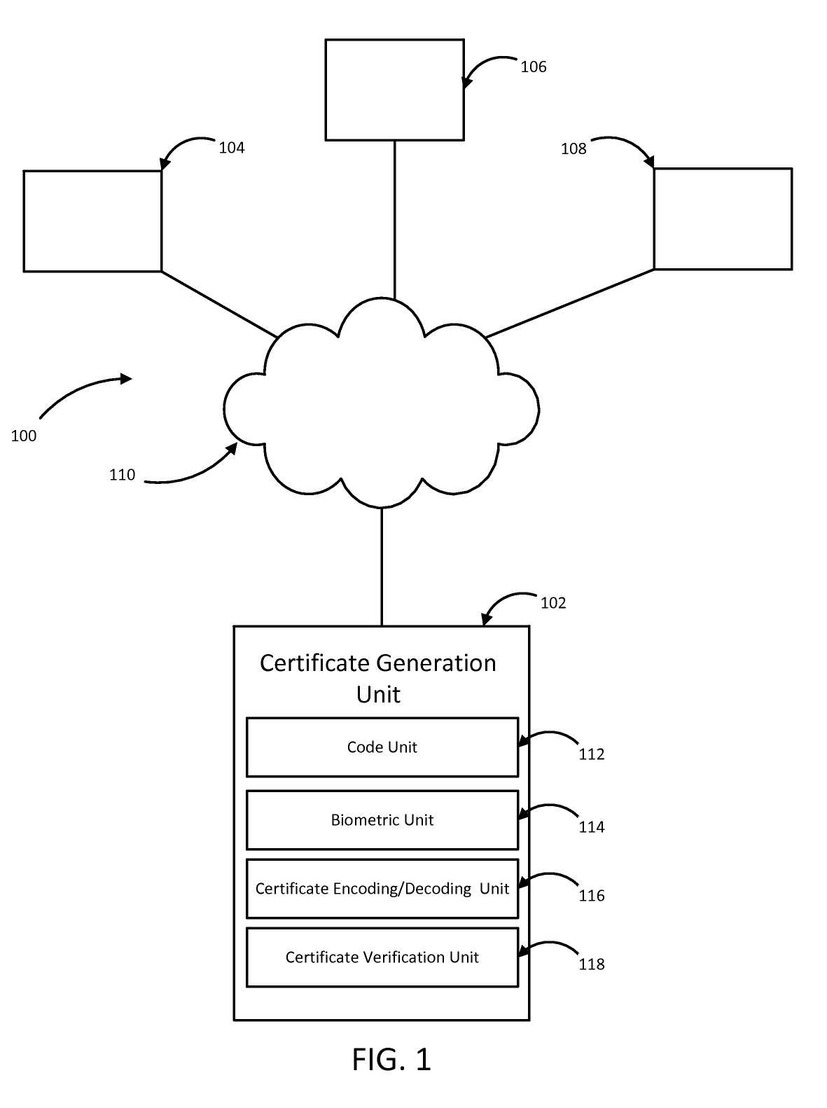

FIG. 1 depicts a block diagram of an Certificate Management System (“CMS”) 100 suitable for use with the methods and systems consistent with the present invention. The CMS 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a Certificate Generation Unit (“CGU”) that includes code unit 112, an biometric unit 114, a certificate encoding/decoding unit 116 and a certificate verification unit 118. The number of computers and the network configuration shown in FIG. 1 are merely an illustrative example. One having skill in the art will appreciate that the CGU 100 may include a different number of computers and networks. For example, computer 102 may include code generation unit 112 as well as one or more of the biometric unit 114 and certificate verification unit 118. Further, the certificate encoding/decoding unit 116 may reside on a different computer than computer 102.

The certificate encoder 114 may be of any known type of encoder including a single Quick Response Code (“QR Code”). If the size of a certificate can be captured in a QR code, then a QR code generator can be used to generate a QR code which may be embedded in the certificate, or can be divided along or the four quadrants of the QR code generating four sub-squares, each of those sub-squares may be rotated 45 degree from horizontal to make the rotated QR code resemble a dice-pattern. The QR code may also be divided into simply four squares by generating a multiple-square pattern.

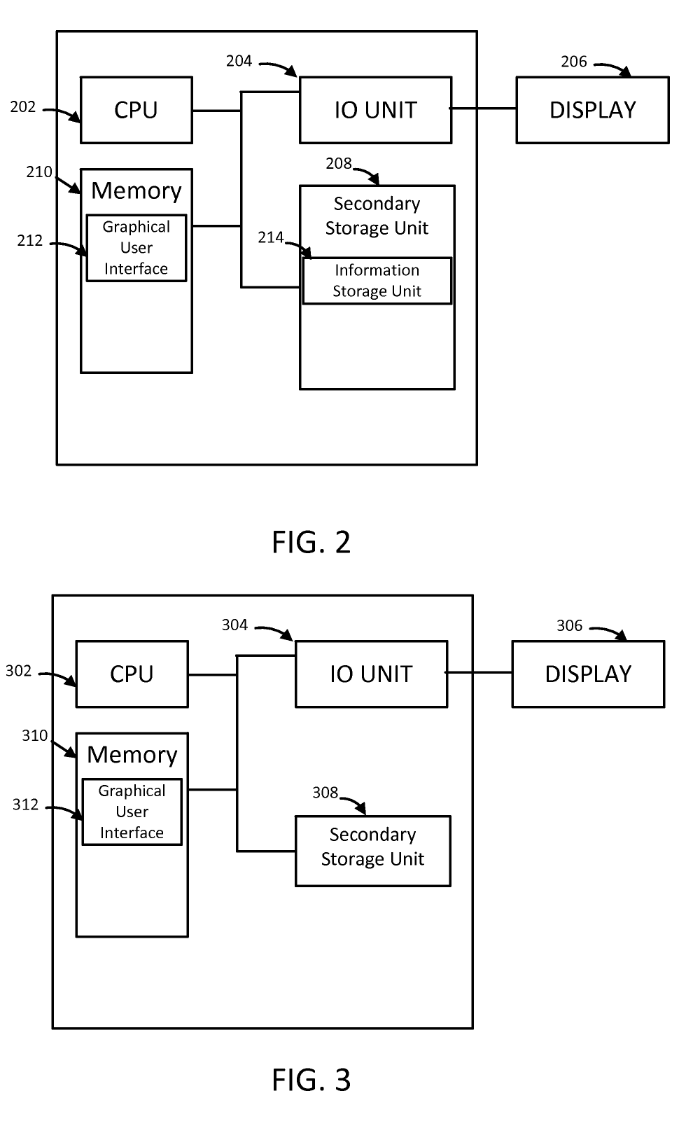

FIG. 2 shows a more detailed depiction of the computer 102. The computer 102 comprises a central processing unit (CPU) 202, an input output (JO) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 that is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (JO) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and 10 unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available HTML viewing software such as, but not limited to, Microsoft Internet Explorer, Google Chrome or any other commercially available HTML viewing software.

The code generation unit 112 is responsible for generating a code from a user's biometric data. The code is presented as an image, which is then embedded into the final certificate. The type of code may be based on the application usage. Examples of codes include, but are not limited to, a code that captures only the biometrics of the user, a code that captures both biometrics and also the content of a certificate, or a code that captures biometrics, content or data that needs to be verified against tampering, and the digital signature of issuing authority or any other code. The certificate encoding/decoding unit 114 generates a certificate using the user's data and the user's code, and then outputs a certificate. The certificate verification unit 118 verifies the owner of the certificate, and also verifies that the certificate has not been tampered with or altered.

The Certificate code may be based on one or more types of input information including, but not limited to, Certificate content that is considered immutable and is tested against tampering, a digital signature of the certificate issuing authority, or user biometric data which may be a user's facial image, finger print, or other biometric information. The Certificate code may also be a combination of two or more different biometric information or a vector of unique feature points extracted from one or more of user's biometric images.

Certificate code is generated by combining various types of data and encoding them in a byte array. One possible format to store certificate code is the following:
certificate_codebyte_count|certificate_code_data
where certificate_code_byte_count is a 4 byte long integer describing the length of certificate code in bytes.

Certificate_code_data may be represented in the following manner:
certificate_content_type|certificate_content_data|digital_signature_byte_count|digital_signature_of issuing_authority|biometric type|bio_metric_data_segment
where certificatecontent_type represents in one byte the type of certificate content stored and the process to be used for content matching (to check tampering).

Some examples of certificate content types include, but are not limited to text and ocr where content is stored in plain text and OCR to be used for matching the content, or image_template_matching where content is stored as an image and template matching to be used to identify the presence of the image on the certificate, etc.

Certificate_content_data may be represented as following:
certificate_content_byte_count|certificate_content in Base64 encoding
where cerificate_content_byte_count is a three bytes field representing the size of certificate content.

Certificate_content may be generated by encoding the content as a Base64 string or any other known encoding types and using certificate_content_type to specify the encoding used. The digital_signature_byte_count object may a two byte field representing the size of digital signature in bytes. A digital signature may be a unique string representing the issuing authority and bio_metric_data_segment is represented as:
bio_metric_data_type|bio_metric_byte_count|bio_metric_data

Bio_{—} metric_{—} data type may be an at least one-byte representation of the type of bio-metric data provided. Bio_metric_data_type may include, but is not limited to face_scan, finger_print, or any other biometric metric. If bio_metric_data_type is a face_scan, only a facial image is stored as the actual bio metric data. If bio_metric_data_type is a finger_print is used, a finger print image may be stored in the memory 210 of the CGU 102. Bio_metric_byte_count may be a number of bytes in bio-metric data. Biometric data is the actual biometric information converted into a digital format.

If the certificate code has multiple biometric data types, then the certificate code may have multiple bio_metric_data_segments. As an illustrative example, a certificate code containing two types of bio-metric data may be represented by:
certificate_content_byte_count|certificate_{—} content in Base64 encoding|digital_signature_byte_count|digital_signature_of issuing_authority|bio_metric_type|bio_metric_data_segment|bio_metric_data_segment

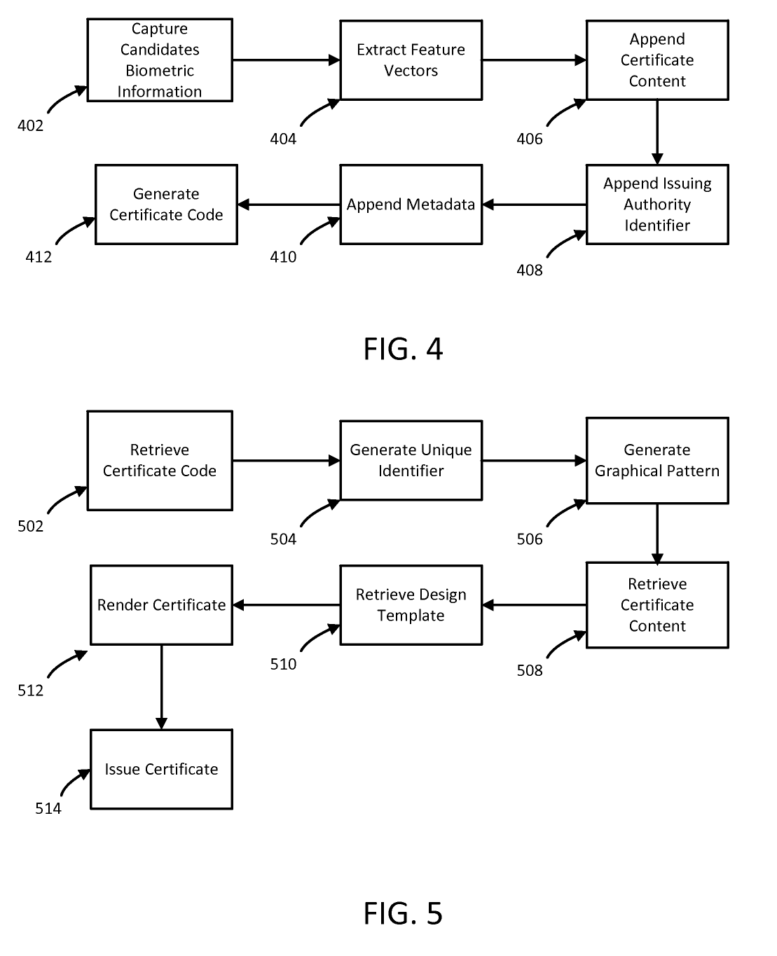

FIG. 4 depicts a schematic representation of a system generating a certificate using the process described herein. In step 402, the biometric unit 114 captures biometric information from a user. The biometric information may be any biometric information including information on fingerprints, iris scans, handwriting samples, facial features or any other biometric information. In step 404, feature vectors are extracted from the biometric information gathered from the user. The feature vectors are any information used to specifically identify the biometric information. In step 408, certificate content is appended onto the biometric feature vectors, where certificate content includes the information presented in the certificate including any text or image in plain or HTML or other standard format. In step 410, information on the authority issuing the identifier is appended onto the biometric feature vectors after the Certificate content is appended to the biometric feature vectors. In step 412, metadata is appended onto the biometric features, where metadata includes information regarding the type of biometrics used and type of encoding used to generate the final certificate code. In step 414, the Certificate Code is generated by encoding the appended biometric feature vector using known standard encoding techniques.

FIG. 5 depicts a schematic representation of a generating a certificate by embedding the certificate code with actual certificate content into a physical or digital certificate. In step 502, the code unit 112 retrieves a Certificate Code using steps depicted in FIG. 4 for a user from the secondary storage unit 208. In step 504, the code unit generates a unique identifier for the Certificate Code. The unique identifier may be a unique number or a series of numbers, a series of characters or a series of numbers and characters used to identify the Certificate Code.

In step 506, the code unit generates a graphical pattern based on the Certificate Code. As an illustrative example, a circular graphical pattern may be generated by embedding the squares into a circle with a diameter equaling the diagonal of the squares in the QR code, or using multiple QR codes. If the Certificate Code is too large to fit in one QR code image, the certificate encoder 114 may convert the Certificate Code into multiple QR codes, each of which may be embedded as is or can be further divided into smaller squares generating dice—or multiple-square—patterns. For example, if a Certificate Code is 10K bytes in size, and a QR code can store 2953 bytes, then the certificate code is divided into four parts each of 2500 bytes represented as four QR codes. A Certificate Code may also be encoded as a string of characters that is embedded in a pattern to generate a certificate, or other encoding. Color may also be used to increase the storage capacity of encoders.

In step 508, the code unit 112 retrieves the Certificate Content from the Certificate Code. In step 510, the code unit 112 retrieves a design template for the Certificate Code from the secondary storage unit 208, where the design template controls how the certificate content is presented in final certificate. As an illustrative example, a design pattern can provided in the design template as a cascading style sheet (CSS) file or in any other standard format capturing the rules for visual presentation of content in the certificate. In step 512, the code unit 112 renders the certificate by applying the design template on the Certificate Content and the graphical pattern generated in Step 506. In step 514, the code unit 112 issues the Certificate in physical or digital form.

As an illustrative example of the operation of verifying a user, an entity verifying a certificate, e.g. an employer (Agent), will send the picture of a candidate along with a scan of certificate to a trusted certificate server (Server). The Server can be running remotely or can also be running as a software program in a security camera or a physical device. The Agent may also be a software program embedded into a security camera or a physical device, that takes a picture of a candidate and another picture of a certificate, and then sends them to the Server to let the candidate perform some restricted action, e.g. entering a building. In case of dealing with certifiable objects, if the code is embedded in the object using an RFID or similar technology, the agent will use corresponding scanning device (e.g. an RFID reader) to capture the code and send that to the Server. The code may also be locally processed by a mobile device attached to the scanning device.

The certificate verification unit 118 can operate by generating a matching score representing how closely the certificate matched with candidate's biometric profile. To verify the certificate image has not been tampered with the certificate verification unit 118 may select a predefined region in the certificate object or certificate image and analyze the content of the region using Object Character Recognition (OCR) on a part of the region and compare the resulting data against the certificate content embedded in certificate code. If the regions in the certificate image or certificate object match to the corresponding region in the certificate code, the certificate can be authenticated.

In another embodiment, the certificate verification unit 118 may analyze an entire certificate image using OCR to identify each character and the corresponding font-size, extract all strings that are of a largest font-size, and use the identified strings to compare to corresponding strings in the certificate code. In another embodiment, the certificate verification unit 118 analyze a whole certificate image using OCR to identify each character and the corresponding font-sizes, identify all strings that are of one or more specific font-sizes and to compare the identified strings to corresponding string in the certificate code.

In another embodiment, the certificate verification unit 118 may analyze an entire image using OCR to identify each characters and the relative font-size, identify all strings that are of one or more specific relative font-sizes (e.g. second-largest, or smallest) and to compare the identified strings to corresponding string in the certificate code. In another embodiment, the certificate verification unit 118 may use a non-OCR based technique, e.g. image segmentation, or template matching to match the content against the content stored in the certificate code

The exact criteria of verifying whether certificate image or object has been altered can be chosen beforehand by the issuing authority. The criteria can either be specified by the issuing authority publicly and can obtained by contacting the issuing authority server, or it can be associated with the issuing authority's digital signature and can be obtained by contacting the issuing authority server or a public database, or it can be encoded in the certificate image or object that was embedded in certificate code.

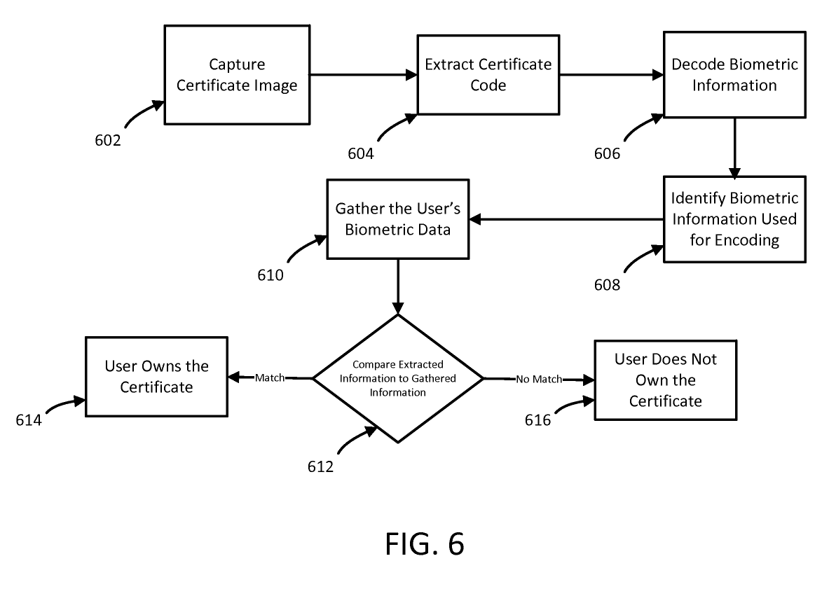

FIG. 6 depicts one a schematic representation of the certificate verification unit 118 verifying a certificate. In step 602, the certificate verification unit 118 captures an image of the certificate image. As an illustrative example, a user may display the certificate image on the screen of a mobile communication device or in a printed form and the certificate verification unit 118 may capture a digital image of the certificate image using a digital image capture device. In step 604, the certificate verification unit 118 extracts the certificate code embedded in the certificate image. In step 606, the certificate verification unit decodes the certificate code from the captured images. In one embodiment, the certificate image is pre-loaded with Certificate private key and the certificate image is decoded using the certificate private key. In step 608, the certificate verification unit 118 determines the type of biometrics used to generate the certificate code. In one embodiment, the type of biometrics are embedded into the image. In another embodiment, the user displaying the certificate image may identify the biometrics used to generate the code. In step 610, the certificate verification unit 118 gathers the same biometric information from the user displaying the certificate image.

As an illustrative example, if the biometric is a facial image, iris scan, finger prints, knuckle or any other type can be captured using a camera or a sensor that the certificate verification unit 118 has access to, then the application requests the candidate to show that biometrics so that the certificate verification unit 118 can capture it In step 612, the certificate verification unit 118 compares the captured biometric with the decoded biometrics and generate a matching score. In step 614, if the captured biometric data matches the decoded biometric data, the user owns the certificate. In step 616, if the captured biometric data does not match the decoded biometric data, the user does not own the certificate.

Depending on the context of use of certificate, there may be numerous variations of certificate codes. For example, compared to the context of verifying all three aspects of certificates (owner, content, and issuing authority), if an application context requires the verification of only one or two aspects of certificates, then only corresponding data needs to be encoded in the certificate code.

Examples of certificates include, but are not limited to: certificates that carry only bio-metric of the student, certificates that carry both biometric information of the student as well as the encoding of the content itself, certificates that carry biometric information of the student as well as encoding of the image of the certificate itself, certificates that carry the facial image of the person and the encoding of the certificate content, or certificates that carry the encoding of the certificate content.

Depending on the type of certificate, the verification step also can be adapted to verify only one or more specific aspects of certifications. Also, depending on the application content, a certificate code can be a direct representation of biometric data without any encoding, so that the verification app is used mainly for matching the candidate against the information stored in the certificate.

All patents referred to herein, are hereby incorporated by reference, whether or not specifically done so within the text of this disclosure. In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A system for generating certificates, the system include a certification generation unit having a processor and a memory with an application in the memory executing the steps of:
generating a digital certificate;
retrieving verification information from a user where the verification information are unique to the user;
appending a certificate content onto the verification information;
appending an issuing authority identifier to the verification information;
appending metadata to the verification information;
generate certificate code based on the appended verification information;
embedding the certificate code into the digital certificate;
encoding the digital certificate with the certificate code; and
issuing a rendered digital certificate.

2. The system of claim 1, wherein the verification information is biometric information from the user.

3. The system of claim 2, wherein the biometric information is at least one of a fingerprint scan, an iris scan, a facial scan or a knuckle scan.

4. The system of claim 1 wherein the verification information is a digital representation of the signature of the user.

5. The system of claim 1 wherein the digital certificate is a digital image.

6. The system of claim 5 wherein the certification generation unit is a mobile device.

7. The system of claim 1 wherein the verification information is a quick response code generated from biometric information gathered from the user.

8. The system of claim 2 wherein the verification information includes information based on features of the biometric data.

9. The system of claim 5 wherein the verification information is embedded into the graphical image as a pattern of shapes on the border of the image.

10. The system of claim 5 wherein the verification information is embedded into the graphical image as a pattern of shaped into the background of the image.

11. A system of verifying a user, the system including a verification unit having a processor and a memory with an application in the memory executing the steps of:
retrieving a digital certificate from a user;
decoding the digital certificate;
extracting verification information from the decoded digital certificate where the verification information is unique to the user associated with the digital certificate;
retrieving verification information from the user;
comparing the verification information from the user with the extracted verification information; and
verifying the digital certificate as being generated by the user if the extracted verification information matches the retrieved verification information.

12. The system of claim 11, wherein the decoded digital certificate directs the verification unit to a location storing verification information.

13. The system of claim 11, wherein the verification unit captures an image of a portion of the user.

14. The system of claim 11, wherein the verification unit is a mobile device.

15. The system of claim 11, wherein the verification information is biometric information from the user.

16. The system of claim 16, wherein the biometric information is at least one of a fingerprint scan, an iris scan, a facial scan or a knuckle scan.

17. The system of claim 11 wherein the verification information is a digital representation of the signature of the user.

18. The system of claim 11 wherein the digital certificate is a digital image.

19. The system of claim 14 wherein the mobile communication device includes a public and private key and a verification information template to decode the digital certificate and extract the verification information.
